(19) United States
(12) Patent Application Publication
(10) Pub. No.: US 2019/0360486 A1
(43) Pub. Date: Nov. 28, 2019

(54) SCROLL COMPRESSOR

(71) Applicant: MITSUBISHI HEAVY INDUSTRIES, LTD., Tokyo (JP)

(72) Inventors: Hirofumi HIRATA, Tokyo (JP); Takahide ITO, Tokyo (JP); Takuma YAMASHITA, Tokyo (JP)

(73) Assignee: MITSUBISHI HEAVY INDUSTRIES, LTD., Tokyo (JP)

(21) Appl. No.: 16/478,760

(22) PCT Filed: Jan. 25, 2018
(86) PCT No.: PCT/JP2018/002176

§ 371 Date: Jul. 17, 2019

(30) Foreign Application Priority Data
Jan. 27, 2017 (JP) 2017-013328

(51) Int. Cl. F04C 18/02; F16J 15/16; F04C 27/00; F04C 29/00

(52) U.S. Cl. CPC F04C 18/02; F04C 29/0042; F04C 27/001; F16J 15/16

(57) ABSTRACT

A scroll compressor includes scroll members that include a compression chamber to compress working fluid, a housing that houses the scroll members, a second driving-side shaft portion that discharges the compressed working fluid from the compression chamber and is rotated around an axis with respect to a second driving-side shaft portion accommodation portion of the housing, and a seal member that is fixed to an outer periphery of the second driving-side shaft portion and comes into contact with an inner peripheral surface of the second driving-side shaft portion accommodation portion for sealing. The second driving-side shaft portion accommodation portion includes a wear resistant portion on the inner peripheral surface coming into contact with the seal member.

### TECHNICAL FIELD

The present embodiments relate to a scroll compressor suitably used for, for example, a co-rotating scroll compressor.

### BACKGROUND ART

A scroll compressor in which both of a driving-side scroll member and a driven-side scroll member are rotated has been well-known (refer to PTL 1). The scroll compressor disclosed in PTL 1 includes a shaft seal (seal member) that seals an outer periphery of a driven shaft (discharge cylinder) provided with a discharge opening from which gas is discharged.

### CITATION LIST

### Patent Literature

[PTL 1] Japanese Unexamined Patent Application, Publication No. Sho62-206282

### SUMMARY OF INVENTION

### Technical Problem

In a case where a rotating shaft and stationary side on outer peripheral side thereof are sealed therebetween, an outer peripheral surface of the shaft that is closer to a rotation center axis is used as a seal contact portion, and an inner peripheral surface of the stationary side on the outer peripheral side is not used as the seal contact portion. This is because on the inner peripheral side close to the rotation center axis, a sliding speed of the seal contact portion can be reduced, and sealing differential pressure on the inner peripheral side is reduced by centrifugal force.

The following issues, however, are found through examination by the present inventors because, in the configuration as disclosed in PTL 1, the compressed working fluid flows while a discharge cylinder is rotated. In the configuration sealing the outer peripheral surface of the discharge cylinder, frictional heat is generated by sliding friction at the seal contact portion, and the discharge cylinder is also heated to high temperature because fluid flowing through the discharge cylinder is heated to high temperature by compression heat as well. Further, since the seal member is typically made of a chemical conversion material such as rubber and a resin, the seal member is poor in heat conductivity and has a small heat dissipation amount. For these reasons, the seal contact portion becomes high temperature. Therefore, a special chemical conversion material that has high heat-resistant temperature, can maintain hardness at high temperature, and is excellent in wear resistance is necessary for the seal member, which increases a cost.

The present embodiments are made in consideration of such circumstances, and an object of the present embodiments is to provide a scroll compressor that makes it possible to seal a space between a rotating discharge cylinder and a housing at low cost.

### Solution to Problem

To solve the above-described issues, a scroll compressor according to the present embodiments adopts the following solutions.

A scroll compressor according to an aspect of the present embodiments includes paired scroll members that include a compression chamber to compress working fluid, a housing that houses the paired scroll members, a discharge cylinder that discharges the compressed working fluid from the compression chamber and is rotated around an axis with respect to the housing, and a seal member that is fixed to an outer periphery of the discharge cylinder and comes into contact with an inner peripheral surface of the housing for sealing.

The seal member is fixed to the outer periphery of a discharge portion, and comes into contact with the inner peripheral surface of the housing for sealing. This makes it possible to avoid the seal member from coming into slide-contact with the outer peripheral surface of the discharge cylinder that is heated to high temperature by the compressed high-temperature working fluid. Therefore, it is unnecessary to use an expensive material having high temperature resistance for the seal member, which makes it possible to achieve cost reduction.

Further, the housing has a configuration to easily dissipate heat to the outside through, for example, exposure to external air. Therefore, even if heat is generated by sliding friction between the seal member and the housing, the heat can be easily dissipated.

Further, in the scroll compressor according to the aspect of the present embodiments, the housing includes a wear resistant portion on the inner peripheral surface coming into contact with the seal member.

Providing the wear resistant portion on the inner peripheral surface of the housing makes it possible to reduce wear by the seal member. As a result, it is possible to suppress lowering of sealability caused by the wear.

Examples of the wear resistant portion include a portion subjected to surface hardening treatment with nickel-phosphorous plating, DLC (Diamond like carbon), or the like, and an iron-based cylindrical member provided on the outer peripheral surface of the discharge cylinder.

Further, in the scroll compressor according to the aspect of the present embodiments, the housing includes a heat insulating portion on side from which the working fluid is discharged, relative to the seal member.

Providing the heat insulating portion on the discharge side of the housing makes it possible to reduce heat conduction from the working fluid that has been heated to high temperature by compression. As a result, it is possible to maintain a contact portion between the seal member and the housing at low temperature.

As a material of the heat insulating portion, a material smaller in heat conductivity than a metal is selected, and for example, a resin is used.

Further, in the scroll compressor according to the aspect of the present embodiments, a cooling portion is provided on the outer peripheral side of the housing.

Forcibly cooling the housing by the cooling portion makes it possible to maintain the seal contact portion at lower temperature.

The cooling portion preferably performs forcible cooling by a cooling medium, and for example, a water jacket through which cooling water flows is used.

Further, the scroll compressor according to the aspect of the present embodiments further includes a driving shaft that is rotationally driven by a driving unit, and the scroll compressor is configured as a co-rotating scroll compressor that includes a driving-side scroll member and a driven-side scroll member as the paired scroll members. The driving-side scroll member is coupled to the driving shaft and performs rotational movement, and the driven-side scroll member receives power transmitted from the driving-side scroll member to perform rotational movement.

### Advantageous Effects of Invention

The seal member comes into contact with the inner peripheral surface of the housing for sealing. Therefore, it is unnecessary to use an expensive material having high temperature resistance for the seal member, which makes it possible to achieve cost reduction.

### BRIEF DESCRIPTION OF DRAWINGS

FIG. 1 is a vertical cross-sectional view illustrating a co-rotating scroll compressor according to an embodiment of the present embodiments.

FIG. 2 is a vertical cross-sectional view illustrating a main part of FIG. 1 in an enlarged manner.

FIG. 3 is a vertical cross-sectional view illustrating a modification 1.

FIG. 4 is a vertical cross-sectional view illustrating a modification 2.

FIG. 5 is a vertical cross-sectional view illustrating a modification 3.

### DESCRIPTION OF EMBODIMENTS

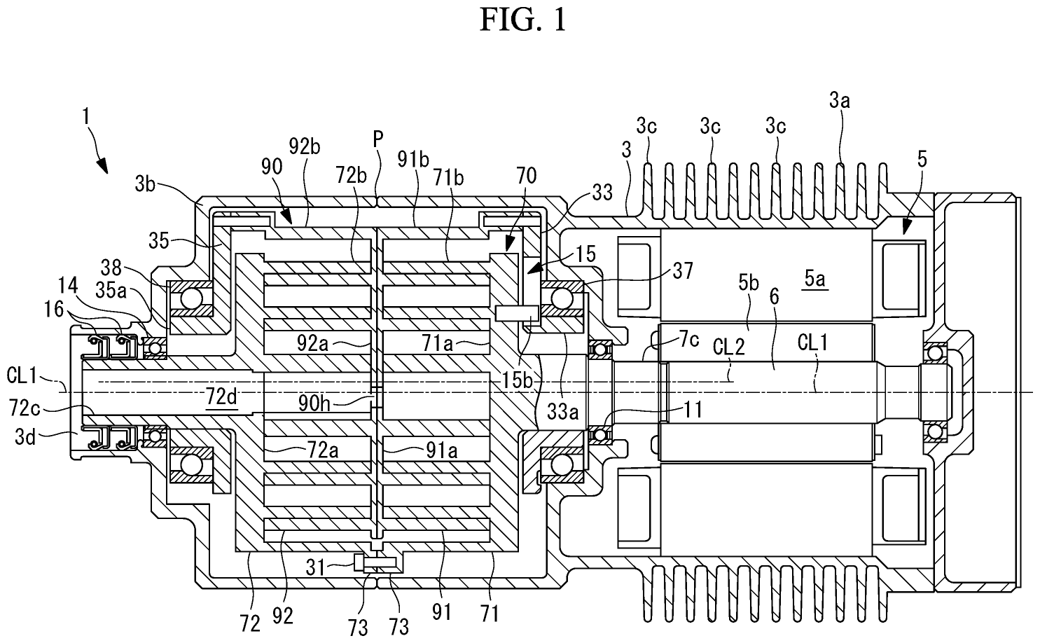

An embodiment of the present embodiments is described below with reference to FIG. 1 and the like.

FIG. 1 illustrates a co-rotating scroll compressor (scroll compressor) 1. The co-rotating scroll compressor 1 can be used as, for example, a supercharger that compresses combustion air (fluid) to be supplied to an internal combustion engine such as a vehicle engine.

The co-rotating scroll compressor 1 includes a housing 3, a motor (driving unit) 5 accommodated on one end side in the housing 3, and a driving-side scroll member 70 and a driven-side scroll member 90 that are accommodated on the other end side in the housing 3.

The housing 3 has a substantially cylindrical shape, and includes a motor accommodation portion (first housing) 3a that accommodates the motor 5, and a scroll accommodation portion (second housing) 3b that accommodates the scroll members 70 and 90.

A cooling fin 3c to cool the motor 5 is provided on an outer periphery of the motor accommodation portion 3a. A discharge opening 3d from which compressed air (working fluid) is discharged is provided at an end part of the scroll accommodation portion 3b. Note that, although not illustrated in FIG. 1, the housing 3 includes an air suction opening from which air (working fluid) is sucked in.

The scroll accommodation portion 3b of the housing 3 is divided at a division surface P that is located at a substantially center in an axis direction of the scroll members 70 and 90. The housing 3 includes a flange portion (not illustrated) that protrudes outward at a predetermined position in a circumferential direction. A bolt or the like as a fastening means is inserted into and fixed to the flange portion, which results in fastening at the division surface P.

The motor 5 is driven by being supplied with power from an unillustrated power supply source. Rotation of the motor 5 is controlled by an instruction from an unillustrated control unit. A stator 5a of the motor 5 is fixed to an inner periphery of the housing 3. A rotor 5b of the motor 5 rotates around a driving-side rotation axis CL1. A driving shaft 6 that extends on the driving-side rotation axis CL1 is connected to the rotor 5b. The driving shaft 6 is connected to a first driving-side shaft portion 7c of the driving-side scroll member 70.

The driving-side scroll member 70 includes a first driving-side scroll portion 71 on the motor 5 side, and a second driving-side scroll portion 72 on the discharge opening 3d side.

The first driving-side scroll portion 71 includes a first driving-side end plate 71a and first driving-side walls 71b.

The first driving-side end plate 71a is connected to the first driving-side shaft portion 7c connected to the driving shaft 6, and extends in a direction orthogonal to the driving-side rotation axis CL1. The first driving-side shaft portion 7c is provided so as to be rotatable with respect to the housing 3 through a first driving-side bearing 11 that is a ball bearing.

The first driving-side end plate 71a has a substantially disc shape in a planar view. The first driving-side wall 71b formed in a spiral shape is provided on the first driving-side end plate 71a. The first driving-side walls 71b are disposed at an equal interval around the driving-side rotation axis CL1.

As illustrated in FIG. 1, the second driving-side scroll portion 72 includes a second driving-side end plate 72a and second driving-side walls 72b. The second driving-side walls 72b are each formed in a spiral shape as with the above-described first driving-side walls 71b.

A second driving-side shaft portion (discharge cylinder) 72c that extends in the driving-side rotation axis CL1 and has a cylindrical shape is connected to the second driving-side end plate 72a. The second driving-side shaft portion 72c is provided so as to be rotatable with respect to the housing 3 through a second driving-side bearing 14 that is a ball bearing. The second driving-side end plate 72a includes a discharge port 72d extending along the driving-side rotation axis CL1.

Two seal members 16 are provided on front end side (left side in FIG. 1) of the second driving-side shaft portion 72c relative to the second driving-side bearing 14, between the second driving-side shaft portion 72c and the housing 3. The two seal members 16 and the second driving-side bearing 14 are disposed at predetermined intervals in the driving-side rotation axis CL1 direction. A lubricant that is grease as, for example, semi-solid lubricant is enclosed between the two seal members 16. Note that the number of seal members 16 may be one. In this case, the lubricant is enclosed between the seal member 16 and the second driving-side bearing 14.

The first driving-side scroll portion 71 and the second driving-side scroll portion 72 are fixed while front ends (free ends) of the walls 71b and 72b corresponding to each other face each other. The first driving-side scroll portion 71 and the second driving-side scroll portion 72 are fixed by bolts (wall fixing parts) 31 that are fastened to respective flange portions 73 provided at a plurality of positions in the circumferential direction. The flange portions 73 are provided so as to protrude outward in a radial direction.

The driven-side scroll member 90 includes a first driven-side scroll portion 91 and a second driven-side scroll portion 92. Driven-side end plates 91a and 92a are located at a substantially center of the driven-side scroll member 90 in the axis direction (horizontal direction in figure). The driven-side end plates 91a and 92a are fixed while rear surfaces (other side surfaces) of the respective driven-side end plates 91a and 92a are superimposed and in contact with each other. Although not illustrated, the fixing is performed by a bolt, a pin, etc. The through hole 90h is provided at a center of each of the driven-side end plates 91a and 92a, and causes the compressed air to flow toward the discharge port 72d.

The first driven-side walls 91b are provided on one side surface of the first driven-side end plate 91a, and the second driven-side walls 92b are provided on one side surface of the second driven-side end plate 92a. The first driven-side walls 91b provided on the motor 5 side from the first driven-side end plate 91a engage with the first driving-side walls 71b of the first driving-side scroll portion 71. The second driven-side walls 92b provided on the discharge opening 3d side from the second driven-side end plate 92a engage with the second driving-side walls 72b of the second driving-side scroll portion 72.

The support members 33 and 35 described later are fixed to the outer peripheries of the first driven-side walls 91b. The second driven-side walls 92b also have the similar configuration.

The first support member 33 and the second support member 35 are provided at the respective ends of the driven-side scroll member 90 in the axis direction (horizontal direction in figure). The first support member 33 is disposed on the motor 5 side, and the second support member 35 is disposed on the discharge opening 3d side. The first support member 33 is fixed to the front ends (free ends) of the first driven-side walls 91b, and the second support member 35 is fixed to the front ends (free ends) of the second driven-side walls 92b. The shaft portion 33a is provided on the center axis side of the first support member 33, and the shaft portion 33a is fixed to the housing 3 through the first support member bearing 37. The shaft portion 35a is provided on the center axis side of the second support member 35, and the shaft portion 35a is fixed to the housing 3 through the second support member bearing 38. As a result, the driven-side scroll member 90 rotates around the second center axis CL2 through the support members 33 and 35.

The pin-ring mechanism (synchronous driving mechanism) 15 is provided between the first support member 33 and the first driving-side end plate 71a. More specifically, a circular hole is provided in the first driving-side end plate 71a, and the pin member 15b is provided on the first support member 33. The pin-ring mechanism 15 transmits the driving force from the driving-side scroll member 70 to the driven-side scroll member 90, and causes the scroll members 70 and 90 to perform rotational movement in the same direction at the same angular velocity.

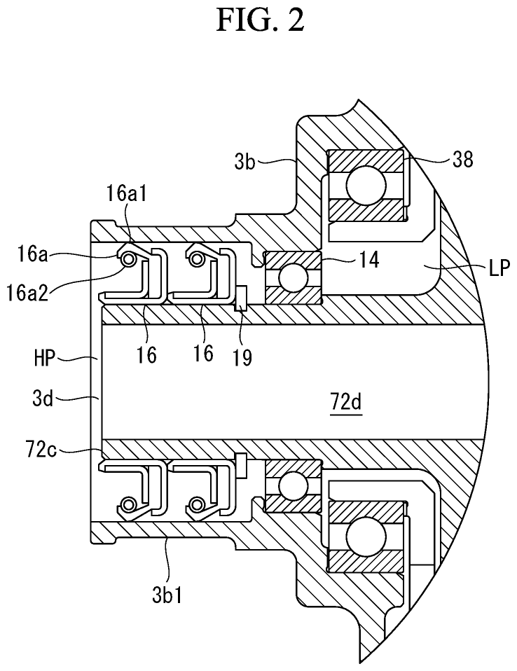

As illustrated in FIG. 2, the scroll accommodation portion 3b includes a second driving-side shaft portion accommodation portion (housing) 3b1 that accommodates the second driving-side shaft portion 72c and the seal members 16.

Each of the seal members 16 is an oil seal. As illustrated in FIG. 2, positions of the two seal members 16 in the axis direction are regulated by a stopper ring 19 that is fitted in an outer peripheral surface of the second driving-side shaft portion 72c. The seal members 16 are fixed to the outer peripheral surface of the second driving-side shaft portion 72c. Accordingly, the seal members 16 rotate together with the second driving-side shaft portion 72c.

Each of the seal members 16 includes a seal lip portion 16a made of a resin. The seal lip portion 16a includes a lip front end part 16a1 that protrudes to the outer peripheral side and comes into contact with an inner peripheral surface of the second driving-side accommodation portion 3b1. An annular spring 16a2 is provided on rear-surface side (inner peripheral side) of the seal lip portion 16a. The lip front end part 16a1 is pressed against the entire circumference of the inner peripheral surface of the second driving-side accommodation portion 3b1 by elastic force of the spring 16a2.

The co-rotating scroll compressor 1 including the above-described configuration operates in the following manner.

When the driving shaft 6 rotates around the driving-side rotation axis CL1 by the motor 5, the first driving-side shaft portion 7c connected to the driving shaft 6 also rotates, and the driving-side scroll member 70 accordingly rotates around the driving-side rotation axis CL1. When the driving-side scroll member 70 rotates, the driving force is transmitted from the support members 33 and 35 to the driven-side scroll member 90 through the pin-ring mechanisms 15, and the driven-side scroll member 90 rotates around the driven-side rotation axis CL2. At this time, when the pin member 15b of the pin-ring mechanism 15 moves while being in contact with the inner peripheral surface of the circular hole, the both scroll members 70 and 90 perform rotational movement in the same direction at the same angular velocity.

When the scroll members 70 and 90 perform rotational movement, the air sucked through the air suction opening of the housing 3 is sucked in from outer peripheral side of each of the scroll members 70 and 90, and is taken into the compression chambers formed by the scroll members 70 and 90. Further, compression is separately performed in the compression chambers formed by the first driving-side walls 71b and the first driven-side walls 91b and in the compression chambers formed by the second driving-side walls 72b and the second driven-side walls 92b. A volume of each of the compression chambers is reduced as each of the compression chambers moves toward the center, which compresses the air. The air compressed by the first driving-side walls 71b and the first driven-side walls 91b passes through the through holes 90h provided in the driven-side end plates 91a and 92a, and is joined with the air compressed by the second driving-side walls 72b and the second driven-side walls 92b. The resultant air passes through the discharge port 72d and is discharged to outside from the discharge opening 3d of the housing 3. The discharged compressed air is guided to an unillustrated internal combustion engine, and is used as combustion air.

The lip front end part 16a1 that is a front end of the seal lip portion 16a of each of the seal members 16 is pressed against the inner peripheral surface of the second driving-side accommodation portion 3b1 by the spring 16a2 provided on the seal lip portion 16a while rotating together with the second driving-side shaft portion 72c. As a result, a high-pressure space HP occupied by the compressed air that has been discharged from the discharge port 72d but before being discharged to the outside from the discharge opening 3d and a low-pressure space LP occupied by sucked air that is sucked from the suction opening of the housing 3 and is taken in from the outer peripheral side of the both scroll members 70 and 90 are sealed by the two seal members 16.

The present embodiment achieves the following action effects.

The seal members 16 are fixed to the outer periphery of the second driving-side shaft portion 72c, and come into contact with the inner peripheral surface of the second driving-side accommodation portion 3b1 for sealing. This makes it possible to avoid the seal members 16 from coming into slide-contact with the outer peripheral surface of the second driving-side shaft portion 72c that is heated to high temperature by the compressed high-temperature air. Therefore, it is unnecessary to use an expensive material having high-temperature resistance as the seal members 16, which makes it possible to achieve cost reduction.

Further, the housing 3 including the second driving-side accommodation portion 3b1 has a configuration to easily dissipate heat to the outside through, for example, exposure to external air. Therefore, even if heat is generated by sliding friction between the seal members 16 and the second driving-side accommodation portion 3b, the heat can be easily dissipated. In particular, in a case where the housing 3 is made of an aluminum alloy or a metal such as iron, a seal contact portion can be maintained at low temperature because of high heat conductivity.

The present embodiment may be modified in the following manner.

### Modification 1

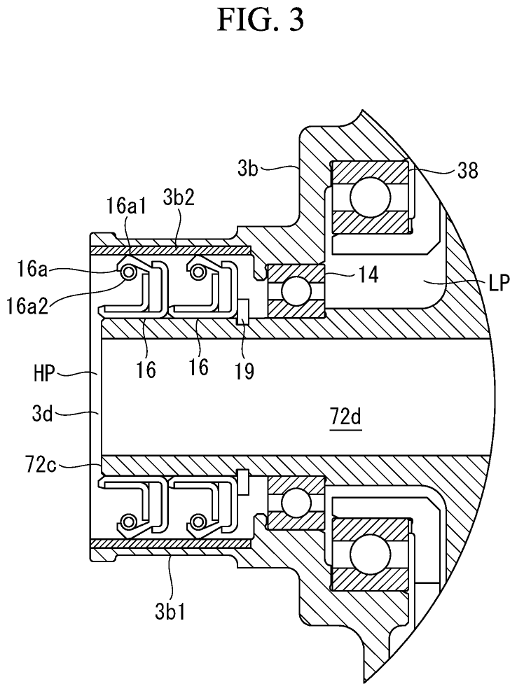

As illustrated in FIG. 3, a cylindrical member (wear resistant portion) 3b2 may be provided over a region with which the lip front end parts 16a1 come into contact, on the inner peripheral surface of the second driving-side accommodation portion 3b1. The cylindrical member 3b2 is made of an iron-based material higher in wear resistance than an aluminum alloy. The cylindrical member 3b2 is press-fitted from the front end side (left side in figure) of the second driving-side accommodation portion 3b1 and is fixed.

Providing the cylindrical member 3b2 in the above-described manner makes it possible to reduce wear caused by the seal members 16, and to suppress lowering of sealability caused by the wear.

Further, a surface-hardened portion may be provided as the wear resistant portion. Examples of the surface-hardened portion include a nickel-phosphorous plating layer or a DLC (Diamond like carbon) layer. In other words, nickel-phosphorous plating or DLC treatment is performed on a predetermined region on the inner peripheral surface of the second driving-side accommodation portion 3b1 that is made of an aluminum alloy.

### Modification 2

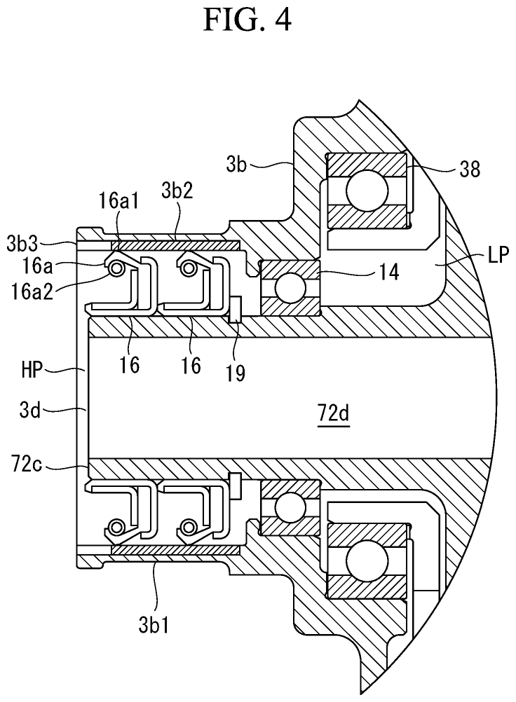

Further, as illustrated in FIG. 4, a heat insulating portion 3b3 may be provided on the front end side (left side in FIG. 4) of the second driving-side accommodation portion 3b1 that is the discharge side of the compressed air. As a material of the heat insulating portion 3b3, a material smaller in heat conductivity than a metal is selected, and for example, a resin is used. This makes it possible to reduce heat conduction from the air that has been heated to high temperature by compression, and to maintain the seal contact portion at low temperature.

### Modification 3

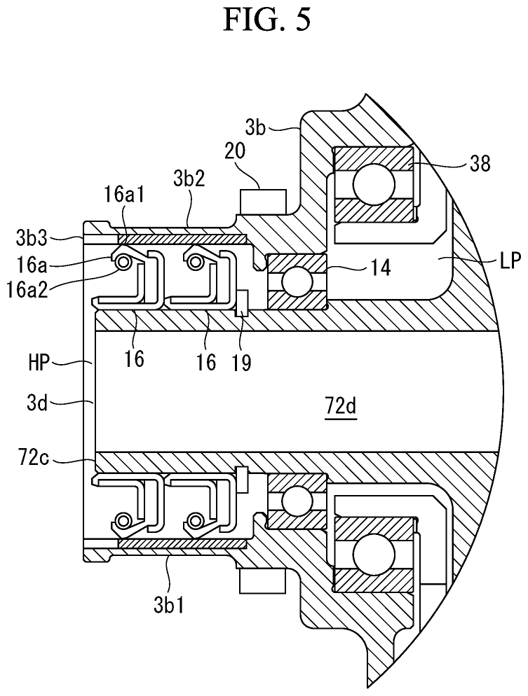

Further, as illustrated in FIG. 5, a cooling portion 20 may be provided on the outer peripheral side of the second driving-side accommodation portion 3b1. The cooling portion 20 preferably performs forcible cooling by a cooling medium, and for example, a water jacket through which cooling water flows is used. As described above, the temperature of the seal contact portion can be maintained at lower temperature by forcibly cooling the second driving-side accommodation portion 3b1 configuring the housing 3, by the cooling portion 20.

In the above-described embodiments and modifications, the co-rotating scroll compressor is used as the supercharger; however, the present embodiments are not limited thereto. The co-rotating scroll compressor is widely used to compress fluid, and for example, can be used as a refrigerant compressor used in air conditioner. In addition, the scroll compressor 1 according to the present embodiments is applicable to an air brake device using air force, as a brake system for a railway vehicle.

### REFERENCE SIGNS LIST

1 Co-rotating scroll compressor (scroll compressor)

3 Housing

3a Motor accommodation portion

3b Scroll accommodation portion

3b1 Second driving-side shaft portion accommodation portion (housing)

3b2 Cylindrical member (wear resistant portion)

3b3 Heat insulating portion

3c Cooling fin

3d Discharge opening

5 Motor (driving unit)

5a Stator

5b Rotor

6 Driving shaft

7c First driving-side shaft portion

11 First driving-side bearing

14 Second driving-side bearing

15 Pin-ring mechanism (synchronous driving mechanism)

15b Pin member

16 Seal member (oil seal)

16a Seal lip portion

16a1 Lip front end part

16a2 Spring

31 Bolt (wall fixing part)

33 First support member

33a Shaft portion

35 Second support member

35a Shaft portion

37 First support member bearing

38 Second support member bearing

70 Driving-side scroll member

71 First driving-side scroll portion

71a First driving-side end plate

71b First driving-side wall

72 Second driving-side scroll portion

72a Second driving-side end plate

72b Second driving-side wall

72c Second driving-side shaft portion

72d Discharge port

73 Flange portion

90 Driven-side scroll member

90h Through hole

91 First driven-side scroll portion

91a First driven-side end plate

91b First driven-side wall

92 Second driven-side scroll portion

92a Second driven-side end plate

92b Second driven-side wall

CL1 Driving-side rotation axis

CL2 Driven-side rotation axis

P Division surface

1. A scroll compressor, comprising:
paired scroll members that include a compression chamber to compress working fluid;
a housing that houses the paired scroll members;
a discharge cylinder that discharges the compressed working fluid from the compression chamber and is rotated around an axis with respect to the housing; and
a seal member that is fixed to an outer periphery of the discharge cylinder and comes into contact with an inner peripheral surface of the housing for sealing.

2. The scroll compressor according to claim 1, wherein the housing includes a wear resistant portion on the inner peripheral surface coming into contact with the seal member.

3. The scroll compressor according to claim 1, wherein the housing includes a heat insulating portion on side from which the working fluid is discharged, relative to the seal member.

4. The scroll compressor according to claim 1, wherein a cooling portion is provided on outer peripheral side of the housing.

5. The scroll compressor according to claim 1, further comprising a driving shaft that is rotationally driven by a driving unit, wherein
the scroll compressor is configured as a co-rotating scroll compressor that includes a driving-side scroll member and a driven-side scroll member as the paired scroll members, the driving-side scroll member being coupled to the driving shaft and performing rotational movement, and the driven-side scroll member receiving power transmitted from the driving-side scroll member to perform rotational movement.

6. The scroll compressor according to claim 1, wherein the seal member includes an annular spring that presses a front end part of the seal member against the inner peripheral surface of the housing.
